(19) United States
(12) Patent Application Publication
(10) Pub. No.: US 2012/0316724 A1
(43) Pub. Date: Dec. 13, 2012

(54) NAVIGATION SYSTEM FOR AN AIRCRAFT AND METHOD OF OPERATING SUCH A NAVIGATION SYSTEM

(75) Inventor: Grégoire Verlut, Munich (DE)

(73) Assignee: EUROCOPTER DEUTSCHLAND GMBH, Donauworth (DE)

(21) Appl. No.: 13/486,040

(22) Filed: Jun. 1, 2012

(30) Foreign Application Priority Data
Jun. 9, 2011 (EP) 11 400033.4

(51) Int. Cl. G01C 21/00; G05D 1/00

(52) U.S. Cl. 701/25; 701/408

(57) ABSTRACT

The invention relates to an onboard navigation system for an aircraft (10), particularly a navigation system for a helicopter and to a method of operating such a navigation system allowing improvement of safety of an aircraft and its crew.

### CROSS REFERENCE TO RELATED APPLICATIONS

This application claims priority to EP 11 400033.4 filed on Jun. 9, 2011, the disclosure of which is incorporated in its entirety by reference herein.

### BACKGROUND OF THE INVENTION

(1) Field of the Invention

The invention relates to a navigation system for an aircraft, particularly to a navigation system for a helicopter allowing computation of guidance and to a method of operating such a navigation system.

(2) Background Art

Emergency medical services operators in helicopters often fly in conditions near to the instrument meteorological condition standards. Thus said operators run a high risk of entering clouds while for most of said operators exclusively visual flights are allowed. When entering into clouds, said operators loose visual reference so that flight into terrain may happen very fast.

The document US2009281684 discloses a flight guidance and navigation display for a helicopter, including a three-dimensional, semicircular flight guidance and navigation tunnel to display a planned flight path of the helicopter. A circular surface is integrated in the flight guidance and navigation tunnel, which circular surface includes a diameter that corresponds to that of the flight guidance and navigation tunnel, for displaying a longitudinal position within the flight guidance and navigation tunnel; a flight path prediction icon for displaying a position of the helicopter relative to the flight guidance and navigation tunnel and a command signal that relates to the air speed, wherein via the command signal a deviation from a reference speed that has been predetermined by flight planning is displayed. Said flight guidance and navigation is no help to avoid terrain, if the planned flight plan is not free from obstacles.

The document US20050273248 discloses a method and device for securing a low altitude flight of a flight vehicle, which involves recording a part of a lateral path of a low level flight path located in front of a present position of an aircraft, during the low level flight. The availability of the lateral path is monitored during the low level flight. Said state of the art is directed to avoid obstacles by taking the aircraft upwards. In case of high clouds that is no remedy for operators exclusively entitled to visual flights.

The document US2004148100 A1 discloses a Driving Route Recording-Move System to help people back their vehicles more easily and safely. The Driving Route Recording-Move System takes parameter data like the steering wheel rotation angle, moving speed and direction in real time, processes the data and saves them in a file if needed or updates the data. The recording time for the parameter data can be adjusted based on various needs. When the vehicle needs to be backed up, the previously stored data in memory or saved in a file can then be recalled and processed by a control device of the Driving Route Recording-Move System to rotate the steering wheel in a desired direction to a desired angle thus causing the vehicle to back up while following, except in a reverse direction, the same route through which the vehicle came in earlier. Said Driving Route Recording-Move System is exclusively suitable for use in earthbound vehicles.

### BRIEF SUMMARY OF THE INVENTION

The object of the invention is to provide a navigation system for an aircraft allowing improvement of the safety of the aircraft and its crew and a method of operating such a navigation system.

The solution is provided with a navigation system with the features of claim 1 and with a method of operating such a navigation system with the features of claim 10. Preferred embodiments are disclosed in the subclaims.

According to the invention an onboard navigation system for an aircraft, particularly navigation system for a helicopter, comprises onboard means for real time detection of data related to at least parts of a path flown by the aircraft after take-off. Onboard real time storing means store said data and onboard computing means of guidance creates a reversion of said flown path, said reversion being derived from said data of at least parts of the flight path. Onboard depicting means are provided to depict this guidance and onboard means such as a switch may be actuated to fly this reverted flight path with preferably at least some support from an onboard automatic flight and control system. The inventive navigation system allows a pilot to fly an aircraft by relying on data detected and stored during the aircrafts antecedent trajectory thus relying on data representing a flight path proven to be safe and improving the safety of the aircraft and its crew. When in danger, e.g., after accidentally entering into clouds and losing sight, the pilot/crew activate the inventive navigation system by using a “red alarm” switch and the inventive navigation system extracts the antecedent flight path known to be safe: from the last take-off until the actuation of the inventive navigation system to provide to the pilot/crew means to fly safely back to the heliport or to a safe point. The antecedent trajectory is reversed: a climb phase becomes a descent phase, an acceleration a deceleration, and so on for all the flight parameters stored previously. By using the onboard automatic flight and control system, it can be ensured that the helicopter will not collide with the terrain. For instance the inventive navigation system will check that the turn radii of the helicopter are compatible with the velocity provided and that the helicopter will not slip outside the turn. The inventive navigation system is suitable for all helicopters with a glass cockpit and preferably for helicopters with an automatic flight and control system (AFCS)/head-up display.

According to a preferred embodiment of the invention onboard computing means are provided. Said computing means assesses whether an acceptable integrity along the reverted flight path is provided or not with a terrain plus obstacle database. The integrity is computed by combining the data related to said flight path with data from said terrain plus obstacle database and gives an estimation of the maximal error between a metered value and the real value for a given standard deviation.

According to a further preferred embodiment of the invention means of monitoring are provided said means of monitoring being suitable to depict that the current integrity in the position is compliant with the integrity stored for the flight path or at least compliant with the acceptable computed integrity. Integrity parameters are monitored to be sure that the helicopter will not deviate too much from the flight plan. Global positioning system (GPS)/Satellite Based augmentation system (SBAS) coverage will provide the integrity needed for the positioning system.

According to a further preferred embodiment of the invention the onboard means of storing the flight path is adapted to store the precise position of the helicopter, integrity of the position computation, attitude, velocities and/or remaining fuel, said parameters being stored preferably during normal flight with a certain amount of said parameters being continuously and regularly stored, without crew action, from take-off to a current position.

According to a further preferred embodiment of the invention these parameters comprise a precise timestamp such as Universal Time Coordinated (UTC) time with milliseconds precision, as delivered by a GPS sensor, an accurate horizontal position of the helicopter: latitude, longitude, altitude, particularly from GPS, Inertial Navigation System (INS), Digital Measuring Equipment (DME)/DME, VHF Omni-directional Radio-range (VOR)/DME as delivered by the GPS sensor or by the Flight Management System (FMS); ground speed, airspeed of the helicopter from using the air data computer and the FMS data, attitude of the helicopter: pitch, roll, yaw, pitch rate, roll rate, yaw rate, pitch acceleration, roll acceleration, yaw acceleration, body accelerations from using an accelerometer and/or gyrometer of the helicopter, integrity of the position, particularly horizontal integrity and vertical integrity, such as delivered by the GPS or by the FMS, and accurate situation of the helicopter, as weight, fuel onboard, such as delivered by the Health Monitoring System (HMS) or by the FMS. The inventive combination of storing the precise flight path, of computing guidance along this reverted flight plan, depicting this guidance to the pilot and offering coupling capabilities allows improved safety for aircraft and pilot/crew.

According to a further preferred embodiment of the invention onboard means of selecting an extract of the flight path for the guidance computation are provided and preferably said means of computing guidance comprise a cross deviation indicator, vertical deviation indicator, required speed, and tunnel in the sky indication and preferably use the displays already installed for depiction and/or head-up displays if provided. If no head-up displays are installed, which is the case for almost 100% of the EMS helicopters, the guidance symbol can still be depicted on the displays in front of the pilot.

According to a further preferred embodiment of the invention said onboard storage means have enough memory to store up to 4 hours and are adapted to helicopter environment.

According to a further preferred embodiment of the invention guidance is computed along the flight plan, to follow the flight plan depending on the current position of the helicopter. Guidance parameters are displayed to the pilot/crew using standard displays and cross-track indicator, vertical track indicator, speed indicator, vertical speed indicator, so that the pilot/crew get all the parameter to maintain the helicopter on the flight plan.

According to a further preferred embodiment of the invention the AFCS, is adapted to perform coupling to one or more axes and if the installed AFCS cannot provide full coupling such as for instance 3 axis AFCS, a partial coupling can be achieved and a visual clue will be still provided to the pilot, to manage the axis, not coupled to the AFCS. Tunnel in the sky can be also used to display the path to follow.

According to a preferred embodiment of the invention a method of operating such a navigation system according to any of the preceding claims is provided with the following steps: Flying an aircraft, Detecting data related to the path flown, Storing said data in onboard storage means, Retrieving said data from said onboard storage means, Providing guidance data by reverting said data by means of computing means, Depicting said reverted data and Flying the aircraft along said reverted data by integrating at least partly the AFCS.

### BRIEF DESCRIPTION OF THE SEVERAL VIEWS OF THE DRAWINGS

According to a further preferred embodiment of the invention said method comprises selection of an extract of said depicted and reverted data.

A preferred embodiment of the invention is shown with the following description and by reference to the attached drawings.

FIG. 1 shows a chart for a flight with onboard navigation system according to the invention.

### DETAILED DESCRIPTION OF THE INVENTION

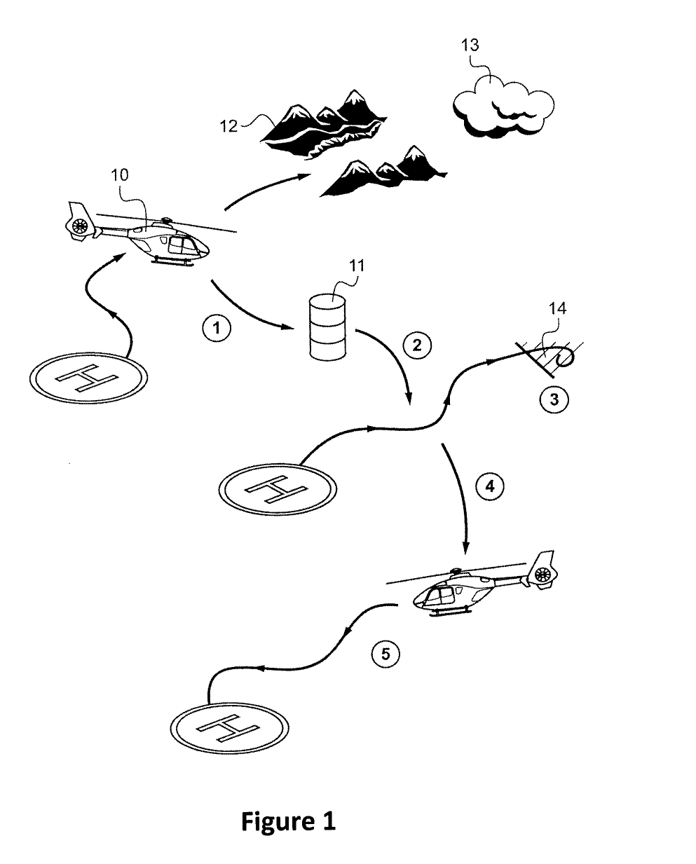

According to FIG. 1 a helicopter 10 with a navigation system takes-off from a heliport H to fly in a first phase 1 in visual meteorological conditions (VMC), allowing the pilot/crew of the helicopter 10 to avoid obstacles and terrain at visual flight. The navigation system of the helicopter 10 comprises onboard means for real time detection (not shown) of data related to the path flown by the helicopter 10. Onboard storing means 11 record continuously said data real time—like a breadcrumb trail—during a flight path taking said helicopter from the heliport H along obstacles 12, such as mountains.

The recorded data comprise the precise position of the helicopter 10, integrity of the position computation, attitude, velocities and/or remaining fuel, said parameters being stored during normal flight continuously and regularly without crew action, from take-off to a current position. The integrity of the position is for a given probability, the estimation of the distance between the measured position and the real position, said integrity of the helicopter 10 being not less than 99.99999%.

After the helicopter 10 has entered in a second flight phase into instrument meteorological conditions (IMC), e.g. by entering into clouds 13, the pilot/crew actuate a switch (not shown), e. g. a “red alarm” to ask for guidance from onboard computing means (not shown). The onboard computing means prepare a reversion of the flight path derived from said data, recorded during the first phase 1 of the visual flight phase, said first phase 1 of the flight phase being safe by definition. By reversing the antecedent trajectory, i.e., a climb phase becomes a descent phase, an acceleration a deceleration, and so on for all the flight parameters stored previously, the onboard computing means offers to the pilot/crew of the helicopter 10 the same way back as the safe antecedent trajectory.

Onboard depicting means (not shown) are provided to depict this computed guidance to the pilot/crew. Onboard means of selecting (not shown) an extract of the flight path for the guidance computation allow the pilot/crew in a third phase of the flight to remove a part 14 of the guidance related to the previous flight that has been passed to retrace the way in vain.

After selection of the extract of the flight path for the guidance computation onboard flying means (not shown) take over to fly the helicopter 10 directly back to the start of the reversion and in a fourth phase along this reverted flight path. Guidance along the reverted flight path and display of the respective guidance parameters with any coupling of an automatic flight and control system (“AFCS”) are provided in a fifth phase back to the heliport H from where the helicopter 10 took off.
Method of Operating the Navigation System

The navigation system is operated with the following steps: flying the aircraft, detecting data related to the path flown, storing said data in onboard storage means, retrieving said data from said onboard storage means by switching, providing guidance data by reverting said data by means of computing means, depicting said reverted data and flying the aircraft back to the point of departure along said reverted data by integrating at least partly the AFCS.

The pilot/crew may select an extract of said depicted and reverted data before flying back along the reverted trajectory of the first phase of the flight path. The computation means will take the helicopter directly to the beginning of the reverted trajectory.

What is claimed is:

1. An onboard navigation system for an aircraft, particularly a navigation system for a helicopter, comprising
onboard means for real time detection of data related to at least parts of a path flown by the aircraft after take-off, said data comprising an accurate horizontal position of the helicopter with reference to its: latitude, longitude, altitude,
onboard means of storing said data in real time,
onboard means of computing guidance along a reverted flown path derived from said data,
onboard means of depicting this guidance, and
onboard means of flying this reverted flight path.

2. The navigation system according to claim 1, wherein an onboard automatic flight and control system is provided, said onboard means of flying this reverted flown path being fully or partially coupled to said onboard automatic flight and control system.

3. The navigation system according to claim 1, wherein means of computing an acceptable integrity along the reverted flown path are provided with a terrain plus obstacle database said integrity being computed by combining the data related to said flown path with data from said terrain plus obstacle database.

4. The navigation system according to claim 1, wherein means of monitoring are provided said means of monitoring being suitable to depict that the current integrity in the position is compliant with the integrity stored for the flight path or at least compliant with the acceptable computed integrity.

5. The navigation system according to claim 1, wherein the onboard means of storing the data related to at least parts of a path flown by the aircraft is adapted to store the precise position of the helicopter, integrity of the position computation, attitude, velocities and/or remaining fuel, said parameters being stored preferably during normal flight with a certain amount of said parameters being continuously and regularly stored, without crew action, from the take-off to a current position.

6. The navigation system according to claim 5, wherein said parameters comprise
a precise timestamp such as UTC time with milliseconds precision, as delivered by an onboard GPS sensor,
an accurate horizontal position of the helicopter (10): latitude, longitude, altitude, particularly from GPS, INS, DME/DME, VOR/DME as delivered by the GPS sensor or by the FMS;
ground speed, airspeed of the helicopter from using the air data computer and the FMS data;
attitude of the helicopter: pitch, roll, yaw, pitch rate, roll rate, yaw rate, pitch acceleration, roll acceleration, yaw acceleration, body accelerations from using an accelerometer and/or gyrometer of the helicopter;
integrity of the position, particularly horizontal integrity and vertical integrity, such as delivered by the GPS or by the FMS, and
accurate situation of the helicopter, as weight, fuel onboard, such as delivered by the HMS or by the FMS.

7. The navigation system according to claim 1, wherein means of selecting an extract of the flown path for the guidance computation are provided.

8. The navigation system according to claim 1, wherein said means of computing guidance comprise a course deviation indicator, vertical deviation indicator, required speed, and tunnel in the sky indication and preferably use the displays already installed for depiction and/or head-up displays if provided.

9. The navigation system according to claim 1, wherein said means of storing has enough memory to store up to 4 hours and is adapted to a helicopter environment.

10. A method of operating a navigation system of an aircraft with the following steps: flying the aircraft; detecting data related to the path flown, said data comprising an accurate horizontal position of the helicopter with reference to its: latitude, longitude, altitude; storing said data in onboard storage means;
retrieving said data from said onboard storage means; providing guidance data by reverting said data by means of computing means; depicting said reverted data; and
flying the aircraft along said reverted data by preferably integrating at least partly the automatic flight and control system.

11. The method according to claim 9, wherein the pilot/crew selecting an extract of said depicted and reverted data before flying back along the reverted trajectory of the first phase of the flight path.
